(19) United States
(12) Patent Application Publication
(10) Pub. No.: US 2022/0362590 A1
(43) Pub. Date: Nov. 17, 2022

(54) LM MASK FIXER

(71) Applicants: Cheng LUO, Rockville, MD (US); Manjarik MRINAL, Arlington, TX (US)

(72) Inventors: Cheng LUO, Rockville, MD (US); Manjarik MRINAL, Arlington, TX (US)

(21) Appl. No.: 17/662,964

(22) Filed: May 11, 2022

Related U.S. Application Data
(60) Provisional application No. 63/187,914, filed on May 12, 2021.

(51) Int. Cl. A62B 23/02; A41D 13/11

(52) U.S. Cl. CPC A62B 23/025; A41D 13/11

(57) ABSTRACT

An article of manufacture for providing a mask fixer to prevent air leakage at the edges is disclosed. The mask fixer includes a face piece and one or more components coupled to the face piece. The face piece includes a central aperture, an exterior surface, and an interior surface. Features, such as a nasal reinforcer, a flange, and/or a sealing loop, may be added to different parts of the face piece to form different embodiments of the mask fixer for different applications. In some embodiments, the mask fixer is used by releasably wearing it outside or inside a surgical or cloth mask to reduce air leakage at the edges. In other embodiments, the mask fixer includes a flange around the central aperture of the face piece. A surgical mask, a cloth mask or a filter is wrapped and fixed around this flange using a band or a snapping mechanism. As such, the mask fixer is integrated with a filter or a surgical or cloth mask to form a new face mask. This new face mask would diminish air leakage at its edges. In all embodiments, the mask fixer is reusable after it is cleaned and sterilized.

### CROSS REFERENCE TO RELATED APPLICATIONS

This application claims benefit of and priority to U.S. Provisional Patent Application No. 63/187,914 filed on May 12, 2021, and is incorporated by reference in its entirety.

### TECHNICAL FIELD OF THE INVENTION

This application relates in general to an article of manufacture for personal protection devices, and more specifically to an article of manufacture for providing a mask fixer and embodiments of face masks incorporating the mask fixer. Some embodiments of the mask fixer can be worn outside or inside a surgical or cloth mask to prevent air leakage of a surgical or cloth mask at the edges. Other embodiments of the mask fixer can be integrated with a filter having a flexible band around the edges, wherein the flexible filter is attached to the face piece of the mask fixer.

### BACKGROUND OF THE INVENTION

As of December 2020, severe acute respiratory syndrome coronavirus 2 (SARS-CoV-2, or COVID-19) has infected more than 69 million individuals worldwide and caused more than 1.5 million deaths. Despite accelerated vaccine development, most societies around the world have relied primarily on mandated social distancing, frequent handwashing, and the use of face masks to reduce transmission of the virus. Currently, more than half the countries around the globe have mandated the wearing of face masks in public, and most of the remaining countries require that masks be worn on public transportation and in indoor spaces such as supermarkets and stores. More than half of the states in the U.S. have mandated the wearing of face masks, and most airlines and the country's ten largest retailers, including Walmart and Target, require masks at all times. As a result, face masks are in high demand as people seek to avoid spreading or contracting the novel coronavirus.

With the increased mask usage, a range of styles and features have been introduced to improve the comfort and function of masks. Members of the public typically use disposable medical or surgical masks, N95 or similar respirators, cloth masks, and bandannas. There is a high demand for masks that are comfortable, well-fitted, effective, breathable, affordable, and re-usable, especially for long-term wear.

One concern is that many masks are loose-fitting, with minimal customizability of fit other than adjustable ear loops and nose wires. The loose fit of masks leads to the masks slipping out of position and gaps provide other routes for germs to escape and enter. In addition, among those who wear eyeglasses, the issue of “fogging” of the lenses due to breath escaping the top edges of the mask is a well-known problem.

Thus, the “edge-leak” problem is a well-recognized one without an apparent solution. Masks with tight seals to the face have been developed for respirators, sleep apnea devices, and industrial uses; however, these masks are far too expensive and unwieldy for widespread use.

Therefore, a need exists for an article of manufacture for providing a mask fixer to prevent air leakage at the edges. Some embodiments of the mask fixer will function as an accessory to any standard surgical or cloth mask to prevent air leakage at the edges, thereby providing better protection over long periods of indoor exposure and preventing the fogging of glasses. In addition, the design of the fixer offers flexibility and customization for a comfortable fit and its material enables affordable mass production. Other embodiments of the mask fixer can be integrated with a filter or a surgical or cloth mask to form a new face mask. This new face mask has reduced air leakage at its edges.

This mask fixer has the potential for widespread use by members of the public to give a more adjustable, secure, effective, and comfortable fit to standard surgical or cloth masks. The present invention attempts to address the limitations and deficiencies in prior solutions according to the principles and example embodiments disclosed herein.

### SUMMARY OF THE INVENTION

In accordance with the present invention, the above and other problems are solved by providing an article of manufacture for a mask fixer. According to the principles and example embodiments disclosed herein, some embodiments of the mask can prevent air leakage of a surgical or cloth mask at the edges. Also, according to the principles and example embodiments disclosed herein, other embodiments of the mask fixer can be integrated with a filter or a surgical or cloth mask to form a new face mask. This new face mask has reduced air leakage at its edges.

In one embodiment, the face mask is an apparatus comprising: a main body, wherein the main body comprises a first surface and a second surface; a central aperture; a plurality of projections, wherein the projections are configured to secure the apparatus to a surface; and, one or more securing devices configured to be received by one or more projections of the plurality of projections. The apparatus is formed by compression or injection molding.

In exemplary embodiments, the apparatus further comprises a first edge abutting at least a portion of the face of a user and a second edge abutting a central aperture, wherein the second edge opposes the first edge. In additional embodiments, at least a portion of the first surface or the second surface abuts at least a portion of the face of a user, and wherein the opposing portion does not. In some embodiments, the apparatus comprises a plurality of projections which are attached to the surface that do not abut the face of a user of the main body, and wherein the plurality of the projections extend outwardly from said surface. Each of the plurality of projections comprises one or more apertures configured to receive one or more securing devices.

In other embodiments, the main body of the apparatus comprises a nasal portion that is pre-curved has a smaller profile than a generic nasal bridge and is configured to expand outwards to conform to the nasal bridge of a user and, wherein conforming to the nasal bridge forms a seal. In some embodiments, the apparatus further comprising a nasal reinforcer simultaneously abutting the second edge and the surface of the main body not abutting the face of a user, wherein the nasal reinforcer is located on a portion of the nasal portion of the main body. In additional embodiments, the nasal reinforcer provides additional local thickness and rigidity maintaining the pre-curved profile of a user's nasal bridge. In some embodiments, the portion of the nasal portion not abutting the nasal reinforce expands outward and conforms to the contour of the user's nasal bridge to make a seal.

In some embodiments, the nasal reinforcer is pre-formed into the main body and is made from the same material as the main body. In other embodiments, the nasal reinforcer is formed separately from the main body, and is subsequently joined to the face piece via casting, over-molding, insertion, screwing fit, or snapping fit.

One embodiment of the apparatus provides securing devices which secure the apparatus to the face of a user by forming one or more loops around a user's head or ears. In some embodiments, the securing devices are pre-formed into the apertures of the plurality of projections of the main body. In some embodiments, the securing devices are formed separately from the main body and subsequently inserted into the apertures of the plurality of projections. The securing devices comprise an adjustable length and are wider than the apertures of the plurality of projections.

In some embodiments, the apparatus further comprising a flange extending outwards from the second edge, wherein the flange and main body form a notch capable of receiving a flexible band.

In another embodiment, the apparatus, further comprises: a filter sheet; and a flexible filter band having a smaller diameter than the main body of the apparatus, wherein the flexible filter band is glued, bonded or sewn to the filter sheet, wherein the filter sheet is attached to the face piece by stretching the flexible filter band around the apparatus and securing the flexible filter band within the notch to form a sealed mask.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIGS. 1A-1C illustrate a first embodiment of a mask fixer to prevent air leakage at the edges according to the present invention.

FIGS. 2A-2B illustrate a user wearing the first embodiment of a mask fixer on top of a surgical mask to prevent air leakage at the edges of the surgical mask according to the present invention.

FIGS. 3A-3B illustrate a user wearing the first embodiment of a mask fixer on the face according to the present invention.

FIGS. 4A-4B illustrate examples of adding one or more bars to the mask fixer's interior surface in the first embodiment of a mask fixer to increase the sealing levels at the edges according to the present invention.

FIGS. 5A-5B illustrate an exemplary embodiment of user head straps attached to the first embodiment of a mask fixer according to the present invention.

FIGS. 6A-6B illustrate an exemplary embodiment of Strap loops added to the first embodiment of a mask fixer according to the present invention.

FIGS. 7A-7B illustrate an embodiment of a mask fixer that includes a nasal reinforcer to prevent air leakage at the edges according to the present invention.

FIGS. 8A-8C illustrate a first exemplary embodiment of a mask fixer that includes a nasal reinforcer according to the present invention.

FIGS. 9A-9D illustrate a user wearing the first exemplary embodiment of a mask fixer that includes a nasal reinforcer according to the present invention.

FIGS. 10A-10D illustrate a second exemplary embodiment of a mask fixer that includes a nasal reinforcer according to the present invention.

FIGS. 11A-11E illustrate a third exemplary embodiment of a mask fixer that includes a nasal reinforcer according to the present invention.

FIGS. 12A-12D illustrate a fourth exemplary embodiment of a mask fixer that includes a nasal reinforcer according to the present invention.

FIGS. 13A-13B illustrate a user wearing the fourth exemplary embodiment of a mask fixer that includes a nasal reinforcer according to the present invention.

FIGS. 14A-14B illustrate a fifth exemplary embodiment of a mask fixer that includes a nasal reinforcer according to the present invention.

FIGS. 15A-15C illustrate an embodiment of a mask fixer that includes a circumferentially extending flange and a flexible band according to the present invention.

FIGS. 16A-16E illustrate a first exemplary embodiment of the mask fixer that includes a mask fixer, a flexible band and a surgical mask according to the present invention.

FIGS. 17A-17C illustrate a user wearing the exemplary embodiments of the mask fixer according to the present invention, wherein a surgical mask having a flexible band on the edges is worn outside of the mask fixer (FIG. 17A), or wherein a mask filter sheet having a flexible band around the edges is worn outside of the mask fixer (FIG. 17B), or wherein a cloth mask having a flexible band on the edges is worn outside of the mask fixer (FIG. 17C).

FIGS. 18A-18B illustrate an exemplary embodiment of a mask filter sheet with a flexible band around the edge of the filter sheet according to the present invention.

FIGS. 19A-19D illustrate an exemplary embodiment of the second new mask that is formed by integrating the mask filter sheet shown in FIGS. 18A-18B with the mask fixer that includes a flange.

FIG. 20 illustrates a first embodiment of adjustable ear loops that can be worn around the user's ears.

FIG. 21 illustrates a second embodiment of adjustable ear loops that can be worn around the user's ears.

FIG. 22A-22B illustrate the face piece of the second embodiment of adjustable ear loops that can be worn around the user's ears.

FIG. 23 illustrates an exemplary embodiment of a new face mask with adjustable ear loops that can be worn around the user's ears.

### DETAILED DESCRIPTION OF THE INVENTION

This application relates in general to an article of manufacture for a personal protection device, and more specifically to an article of manufacture for providing a mask fixer. Some embodiments of the mask can prevent air leakage of a surgical or cloth mask at the edges. Other embodiments of the mask fixer can be integrated with a filter or a surgical or cloth mask to form a new face mask. This new face mask has reduced air leakage at its edges.

### I. Definitions

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “individual” and “user” refer to an entity, e.g., a human, using an article of manufacture for providing a mask fixer to prevent air leakage at the edges associated with the invention. The term user herein refers to one or more users.

The term “invention” or “present invention” refers to the invention being applied for via the patent application with the title “LM Mask Fixer.” Invention may be used interchangeably with fixer or mask fixer.

All ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

### Examples

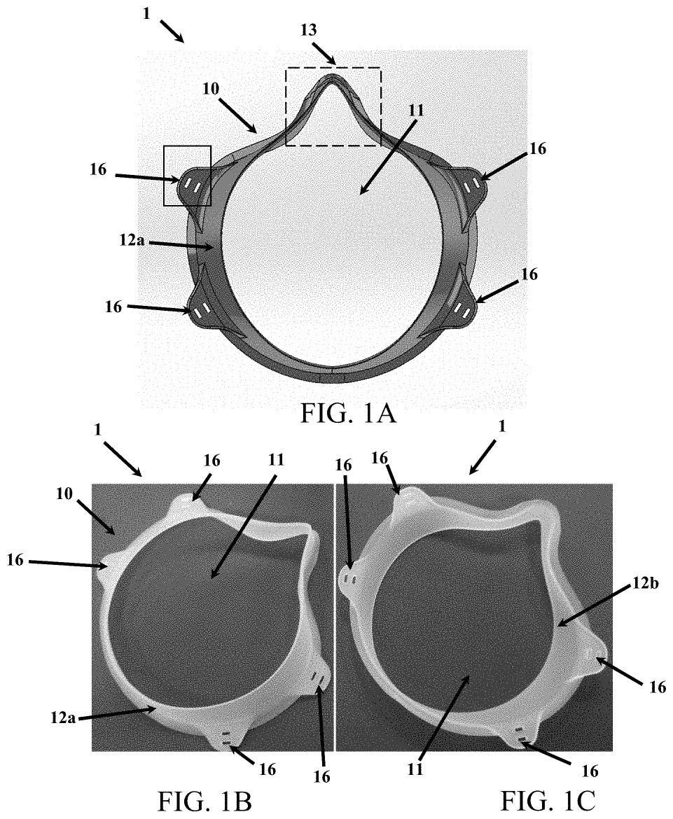

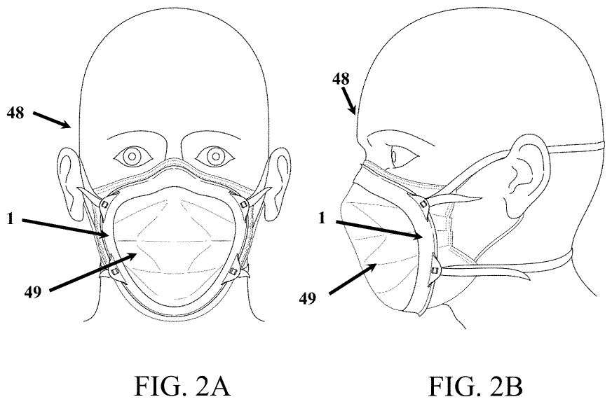

As shown in FIGS. 1A-1C, a mask fixer 1 comprises a face piece 10 having: a central aperture 11, an exterior surface 12a, and an interior surface 12b opposite the exterior surface 12a. For reference purposes, the exterior surface 12a is an outward facing surface with respect to a user, and the interior surface 12b is an inward facing surface (towards a user) when the mask fixer 1 is worn by a user. FIGS. 2A-2B illustrate a user wearing a first embodiment of the mask fixer 1 on the top of a surgical mask 49 to prevent the air leakage of the surgical mask 49 at the edges.

The face piece 10 has a 3D profile as shown in FIGS. 1A-1C and the face piece 10 is flexible. The 3D shape of the face piece 10 enables the mask fixer 1 to have an initial match with a user's face 48. The inner surface circumferential portions of the face piece 10 that contact a user's face 48 can be curled inward, and due to the elasticity of the material, these portions further confirm to a profile of the user's face 48, sealing the edge of a face mask at the user's cheeks.

The nose portion 13 of the face piece 10 shown in the dashed line box in FIG. 1A has a pre-curved profile. As such, the nose portion 13 has a smaller profile than a user's generic nasal bridge. Upon wearing the mask fixer 1, the nose portion 13 of the face piece 10 is pushed outward until it conforms to the contour of the user's nasal bridge, creating a good fit between them and sealing the edge of a face mask at the user's nasal bridge.

The face piece 10 is made from a flexible polymer. In some cases, the flexible polymer can be any flexible polymer not inconsistent with the objectives of this disclosure, such as a flexible polymer suitable for compression or injection molding. In some instances, the flexible polymer is thermoplastic polyurethane (TPU), thermoplastic elastomer (TPE), thermoplastic polyurethane (TPU) or thermoplastic elastomer (TPE), soft-flexible polylactic acid (PLA), soft-flexible Polydimethylsiloxane (PDMS), elastomeric polyurethane (EPU), flexible polyurethane (FPU) or silicone.

In preferred embodiments, the face piece 10 is formed by compression or injection molding of silicone. The resulting body is substantially nonporous, having a porosity of less than 0.5%, less than 0.1%, less than 0.05%, less than 0.01%, or less than 0.001%.

The face piece 10 can have any shape not inconsistent with the objectives of this disclosure. In some instances, the face piece 10 has a shape that, when assembled, will conform to the contours of a human face. In some embodiments, the face piece 10 has an approximate oval shape when viewed normal from the exterior surface. In a preferred embodiment, the face piece 10 has a cup-shaped configuration, as shown, for example, in FIGS. 1-23. The face piece 10 can have a thickness of 0.1-6 mm, 0.1 mm, 0.2 mm, 0.3 mm, 0.4 mm, 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, 2 mm, or up to 6 mm. In some cases, the face piece 10 can have an approximately uniform thickness throughout. In other cases, the face piece 10 can have varying thicknesses. For example, in some cases, the inner surface circumferential portions of the face piece 10 that contact a user's face 48 can have a reduced thickness compared to central portions proximate the central aperture 11 or areas forming strap receiving apertures 16 (described in more detail below).

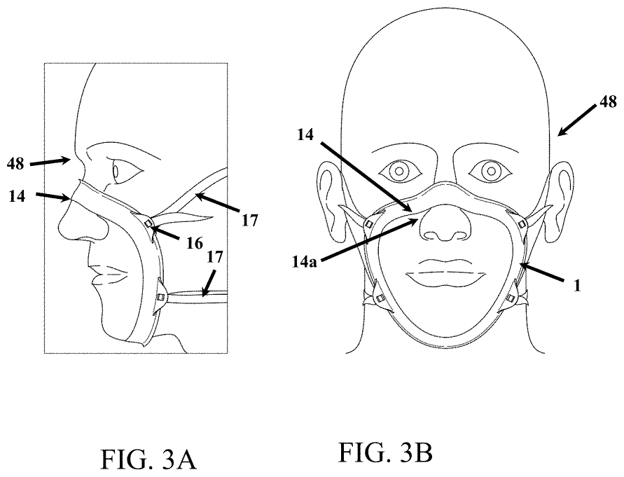

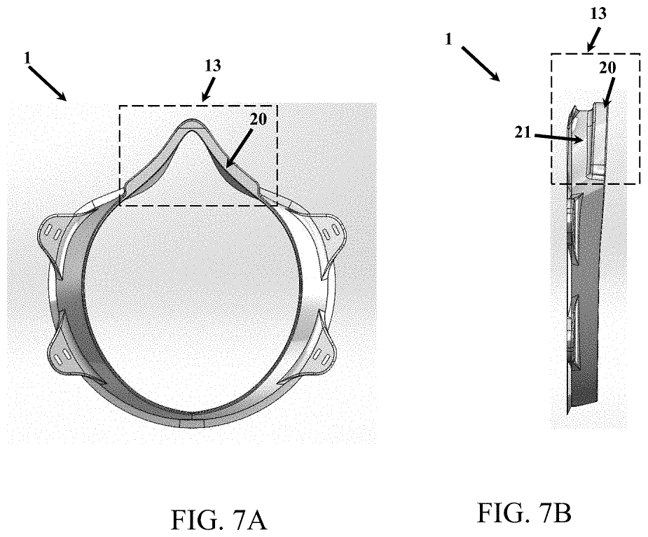

FIGS. 3A-3B illustrate a user wearing the first embodiment of the mask fixer 1 according to the present invention. In an aspect of the invention, the inner edge 14 of the face piece 10 creates a gap 14a between the nose of a user and the face piece 10 (FIG. 3B). In such an aspect, the gap 14a allows for the use of a nasal reinforcer 20, wherein the reinforcer 20 is configured to fit in the gap 14a as to either not abut or slightly abut the nose of a user. This has two advantages. A first advantage is to provide enough room to incorporate a nasal reinforcer 20 into the inner edge 14 of the face piece 10, as shown below with respect to FIGS. 7A-7B. This first advantage also ensures that the nasal reinforcer 20 does not touch or just slightly touches the user's nasal bridge, which prevents the nasal reinforcer 20 from bringing too much pressure on the user's nose. When the mask fixer 1 is worn inside a face mask, a second advantage arises. The face mask also contacts the inner edge 14. This contact provides an additional loop to seal the face mask, complementing the pre-existing sealing at the edge of the face mask.

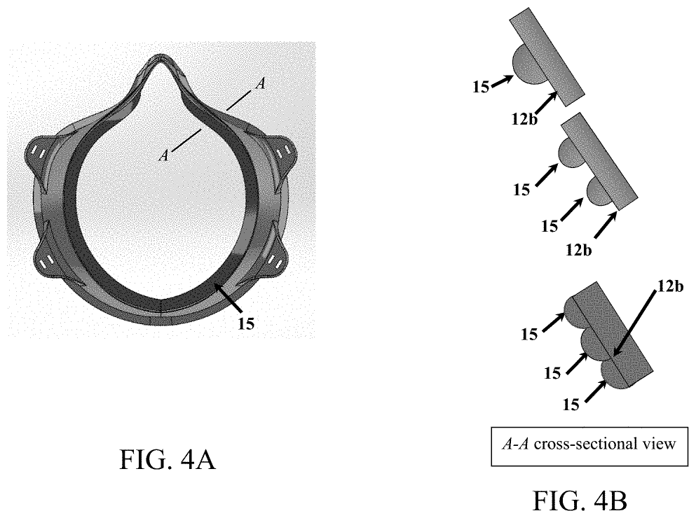

In some cases, a bar 15 with a semi-circular, rectangular or another cross-sectional shape can be further added on the middle of the face piece's interior surface 12b (FIGS. 4A-4B). The inner surface circumferential portions of the face piece 10 seals the edge of the face mask at the user's cheeks. Since the bar 15 has a radius smaller than the inner surface circumferential portions of the face piece 10, it provides a second loop to seal the edges of the face mask. Additional bars 15 may be added on the interior surface to provide more sealing loops as shown in FIG. 4B. The inner surface 12b of the face piece 10 can also be made as a wavy surface to provide additional sealing.

Central aperture 11 can have any shape not inconsistent with the objectives of this disclosure, such as a shape that permits airflow to occur through that is sufficient for a user to breathe. In some embodiment, central aperture 11 is shaped as a triangle, a quadrilateral, a circle, or an oval. The quadrilateral can comprise a rectangle, a square a rhombus, a trapezium, a kite, a pentagon, a hexagon, or a polygon. In a preferred embodiment, central aperture 11 has an approximately teardrop profile, as shown in FIGS. 1-23.

In some embodiments, the face piece 10 comprises one, two, three, four or more pairs of strap receiving apertures 16 positioned on opposite sides, such as is illustrated in the solid line box in FIG. 1A. The strap receiving apertures 16 extend from the face piece 10 further comprising one or more aperture(s) 16. In such an aspect, the one or more apertures 16 are configured to receive a securing device, as described below, to secure a mask fixer 1 to a user. As an example shown in FIG. 3A, user head straps 17 can be positioned in strap receiving apertures 16 to secure the mask fixer 1 to a user's face 48. In some cases, the face piece 10 comprises two, four, or six flaps, tabs, or projections through which strap receiving apertures 16 are formed, as illustrated for instance in FIGS. 1A-1C. Each flap includes one, two, or more strap receiving apertures 16.

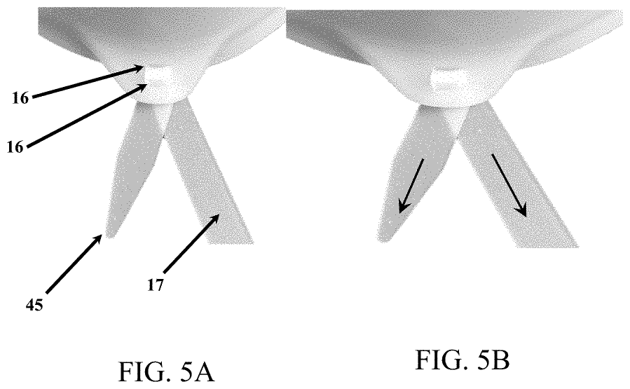

FIG. 5A illustrates an exemplary method for securing a user head strap 17 to two strap receiving apertures 16. This method provides an advantage as the user head straps 17 are self-locked in a set of strap receiving apertures 16. The user head strap 17 is wider than its two strap receiving apertures 16. Thus, the user head strap 17 is squeezed inside its two strap receiving apertures 16, as shown in FIG. 5A. This arrangement of a user head strap 17 through multiple strap receiving apertures 16 increases the friction between the user head strap 17 and its receiving apertures 16. As validated by experiments, the friction is large enough to lock a user head strap 17 and avoid its slipping inside its two strap receiving apertures 16 during the wearing of the mask fixer 1. Meanwhile, the friction can be overcome by pulling the user head strap 17 using fingers, as illustrated in FIG. 5B. Once the pulling stops, the user head strap 17 is locked in its two strap receiving apertures 16. As such, the lengths of the user head straps 17 can be locally adjusted to make the mask fixer 1 have a better face fit and cause less pressure on the user's face 48.

The user head straps 17 are made from a flexible polymer. In some cases, the flexible polymer can be any flexible polymer not inconsistent with the objectives of this disclosure, such as a flexible polymer suitable for compression or injection molding. In some instances, the flexible polymer is thermoplastic polyurethane (TPU), thermoplastic elastomer (TPE), thermoplastic polyurethane (TPU) or thermoplastic elastomer (TPE), soft-flexible polylactic acid (PLA), soft-flexible Polydimethylsiloxane (PDMS), elastomeric polyurethane (EPU), flexible polyurethane (FPU) or silicone. In preferred embodiments, the user head straps 17 are made from silicone, and they are formed by compression or injection molding.

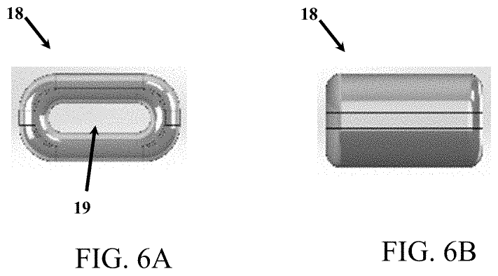

Strap loops 18 are included some embodiments of the mask fixer 1 to fix the strap heads 45 on the user head straps 17 (FIG. 5A). As shown in FIGS. 6A-6B, each strap loop 18 has a channel 19. The height of the channel 19 is more than the total thickness of two user head straps 17, making it easy to pierce both a user head strap 17 and its strap head 45 through the channel 19 to arrange the strap head 45 on the user head strap 17. Furthermore, the user head strap 17 is wider than the loop's channel 19, squeezing the strap 17 inside the channel 19. This arrangement provides a friction force to stop the movement of the strap loop 18 along the user head strap 17, when a mask fixer 1 is worn by a user.

In some embodiments, the strap loops 18 are made from a flexible polymer. In some cases, the flexible polymer can be any flexible polymer not inconsistent with the objectives of this disclosure, such as a flexible polymer suitable for compression or injection molding. In some instances, the flexible polymer is thermoplastic polyurethane (TPU), thermoplastic elastomer (TPE), thermoplastic polyurethane (TPU) or thermoplastic elastomer (TPE), soft-flexible polylactic acid (PLA), soft-flexible Polydimethylsiloxane (PDMS), elastomeric polyurethane (EPU), flexible polyurethane (FPU) or silicone.

In other embodiments, the strap loops 18 can be made from any rigid polymer not inconsistent with the objectives of this disclosure, such as 3D printable, compression or injection moldable, or castable rigid polymers. Exemplary rigid polymers include polyphenylsulfone (PPSU), polyvinyl chloride (PVC), polypropylene (PP), polyethylene (PE), polystyrene (PS), nylon, polyethylene terephthalate (PET), polyimide (PA), polycarbonate (PC), acrylonitrile butadiene (ABS), polyetheretherketone (PEEK), polyurethane (PU), polylactic acid (PLA), Polycaprolactone (PCL), high-density polyethylene (HDPE), polyethylene high-density (PEHD) or any combination thereof.

In some cases, the strap loops 18 can be made from a metal. Exemplary metals include aluminum, copper, or steel.

In preferred embodiments, the strap loops 18 are made from silicone, and they are formed by compression or injection molding.

As shown in FIGS. 7A-7B, in some embodiments of the mask fixer 1, a nasal reinforcer 20 is added to the nose portion 13 of the face piece 10 to increase the bending stiffness of this nose portion 13. The nasal reinforcer 20 has the same profile as the nose portion 13. It is located on the front of the nose portion 13. Due to the reinforcement of the reinforcer 20, the face piece's nose portion 13 approximately maintains its pre-curved profile and is not much affected by the pulling force applied to wear the mask fixer 1. A back part 21 of the nasal portion 13, which does not have direct contact with the nasal reinforcer 20 seen in FIG. 7B along the direction normal to a user's nasal bridge while has direct contact with the user's nasal bridge, can still be locally pushed outward by the nasal bridge, matching and sealing the nasal bridge.

In some embodiments, the nasal reinforcer 20 is made from a flexible polymer. In some cases, the flexible polymer can be any flexible polymer not inconsistent with the objectives of this disclosure, such as a flexible polymer suitable for compression or injection molding. In some instances, the flexible polymer is thermoplastic polyurethane (TPU), thermoplastic elastomer (TPE), thermoplastic polyurethane (TPU) or thermoplastic elastomer (TPE), soft-flexible polylactic acid (PLA), soft-flexible Polydimethylsiloxane (PDMS), elastomeric polyurethane (EPU), flexible polyurethane (FPU) or silicone.

In other embodiments, the nasal reinforcer 20 can be made from any rigid polymer not inconsistent with the objectives of this disclosure, such as 3D printable, compression or injection moldable, or castable rigid polymers. Exemplary rigid polymers include polyphenylsulfone (PPSU), polyvinyl chloride (PVC), polypropylene (PP), polyethylene (PE), polystyrene (PS), nylon, polyethylene terephthalate (PET), polyimide (PA), polycarbonate (PC), acrylonitrile butadiene (ABS), polyetheretherketone (PEEK), polyurethane (PU), polylactic acid (PLA), Polycaprolactone (PCL), high-density polyethylene (HDPE), polyethylene high-density (PEHD) or any combination thereof.

In some cases, the nasal reinforcer 20 can be made from a combination of rigid and/or flexible polymers. For instance, the core of the nasal reinforcer 20 is made of PC, and the remaining portions of the nasal reinforcer 20 can be made with silicone, with the face piece 10 also made of silicone. In this example, silicone in the nasal reinforcer 20 helps to bond the nasal reinforcer 20 to the face piece 10. Also, silicone is generally softer than PC, so the mask fixer 1, which includes the nasal reinforcer 20, can still be comfortable to wear.

In some cases, the nasal reinforcer 20 can be made from a metal. Exemplary metals include aluminum, copper, or steel.

In preferred embodiments, the nasal reinforcer 20 is part of the face piece 10, and it is manufactured with the face piece 10 at the same time using the same process (e.g. compression or injection molding) and the same material (e.g., silicone).

In other embodiments, the nasal reinforcer 20 is fabricated separately from the face piece 10 and it is then integrated into the face piece 10 using a casting, over-molding, insertion or snapping-fit method, as described below in detail.

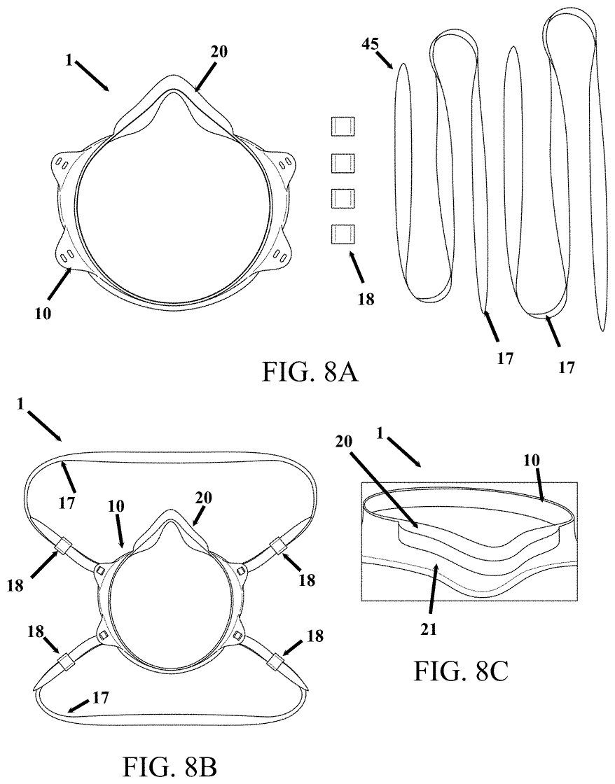

Multiple adjustments were made to the face piece 10 and the nasal reinforcer 20 to create various embodiments of the mask fixer 1. Five exemplary embodiments of the mask fixer 1 that include the nasal reinforcers 20 are shown in FIGS. 8-14 herein. In addition to the nasal reinforcer 20, as an example shown in FIG. 8A, each of these five exemplary embodiments of the mask fixer 1 also includes a face piece 10, two user head straps 17, and four strap loops 18.

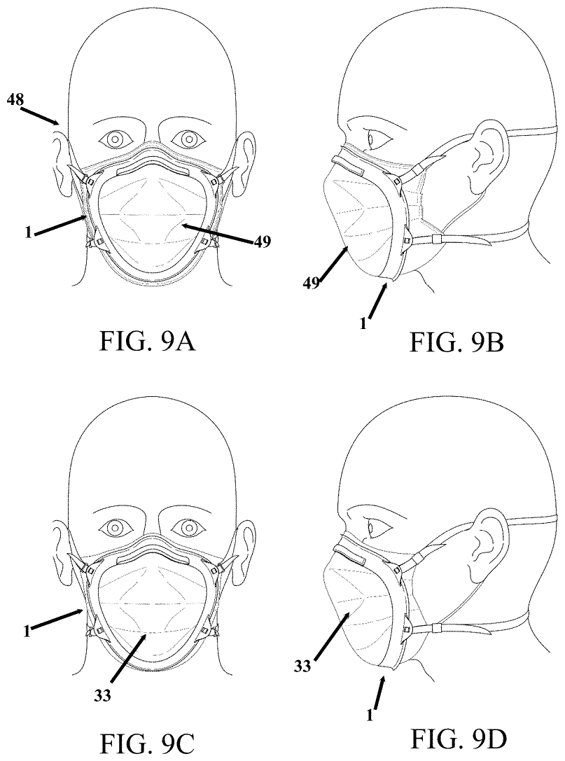

As illustrated in FIGS. 8A-8C, in the first exemplary embodiment of the mask fixer 1, which includes the nasal reinforcer 20, the nasal reinforcer 20 is part of the face piece 10, and it is formed on the face piece 10 by directly thickening the front of the nasal portion 13 of the face piece 10. Both the nasal reinforcer 20 and the face piece 10 are made from silicone. FIGS. 9A-9B illustrate a user wearing this first exemplary embodiment of the mask fixer 1 on top of a surgical mask 49 to prevent air leakage at the edges of the surgical mask. FIGS. 9C-9D show the same user wearing this first embodiment of the mask fixer 1 on top of a cloth mask 33 to prevent air leakage at the edges of the cloth mask 33.

The first exemplary embodiment of the mask fixer 1, which includes the nasal reinforcer 20, is also a preferred embodiment. As an example, all parts of this preferred embodiment will be made from silicone, the nasal reinforcer 20 will be formed with the face piece 10 at the same time using the same process (e.g., compression or injection molding), and the two user straps 17 and the four or more strap loops 18 will be formed separately but using the same process (e.g., compression or injection molding) and the same material (i.e., silicone). The silicone materials used for different parts of the mask fixer in this preferred embodiment may have different harnesses. For instance, the silicone material used for the face piece 10 may have a shore hardness of 60 A or 70 A, while the silicone material for the user straps 17 may have a shore hardness of 30 A.

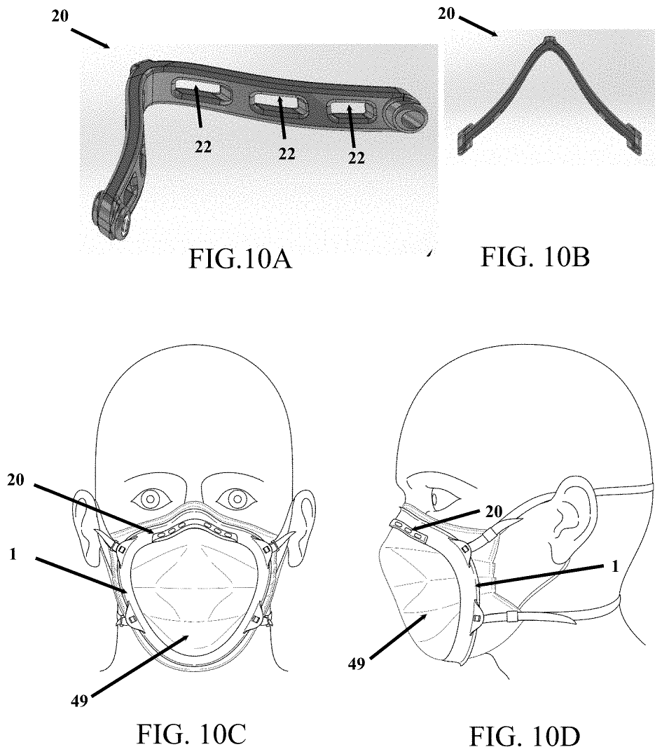

As illustrated in FIGS. 10A-10D, in a second exemplary embodiment of the mask fixer 1, which includes the nasal reinforcer 20, the nasal reinforcer 20 is made from a rigid polymer. The nasal reinforcer 20 is formed separately from the face piece 10. The nasal reinforcer 20 has through-holes 22. The number of the through-holes may be one, two or more. The nasal reinforcer 20 is over-molded on the face piece's nasal portion 13. During the over-molding process, the material of the face piece 10 (e.g., silicone) goes through the through-holes 22 of the nasal reinforcer 20 and also wraps around the nasal reinforcer 20, fixing the nasal reinforcer 20 on the face piece 10.

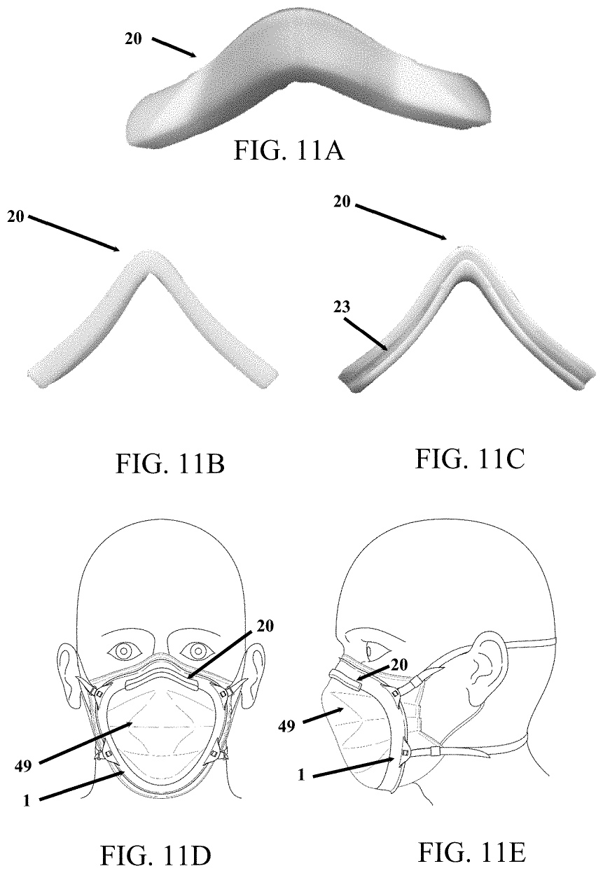

As illustrated in FIGS. 11A-11E, in a third exemplary embodiment of the mask fixer 1, which includes the nasal reinforcer 20, the nasal reinforcer 20 is also made from a rigid polymer. The nasal reinforcer 20 is formed separately from the face piece 10. The nasal reinforcer 20 has a channel 23. The width of the channel 23 is smaller than the thickness of the membrane in the face piece's nasal portion 13. The nasal reinforcer 20 is inserted into and fixed on the face piece's nasal portion 13, by squeezing the face piece's nasal portion 13 into the channel 23 of the nasal reinforcer 20.

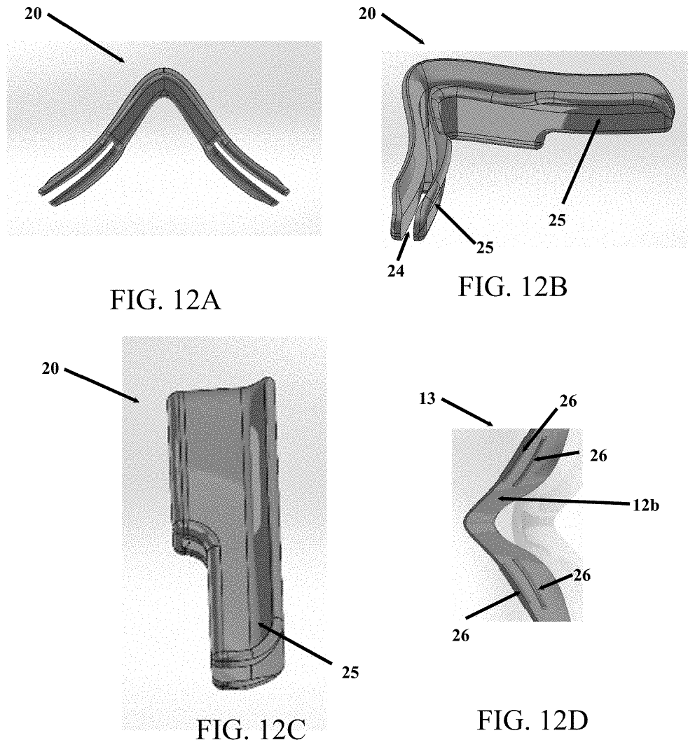

In a fourth exemplary embodiment of the mask fixer 1, which includes the nasal reinforcer 20, the nasal reinforcer 20 is also made from a rigid polymer and is formed separately from the face piece 10. As illustrated in FIGS. 12A-12C, the nasal reinforcer 20 has a channel 24 and two narrow ends 25. As illustrated in FIG. 12D, the interior surface of the face piece's nasal portion 13 comprises two pairs of protruded strips 26. The exterior surface of the face piece's nasal portion 13 also comprises two pairs of protruded strips 26. After the nasal reinforcer 20 is inserted into the face piece's nasal portion 13, each narrow end 25 of the nasal reinforcer 20 is locked inside two pairs of the nasal portion's protruded strips 26: one pair of the extruded strips 26 is located on the exterior surface of the nasal portion 13, and the other pair is positioned on the interior surface of the nasal portion 13.

In the fourth exemplary embodiment of the mask fixer 1, which includes the nasal reinforcer 20, as the nasal reinforcer 20 is inserted into the nasal portion 13, the face piece's nasal portion 13 is squeezed inside the channel 24. The locking of the nasal reinforcer's narrow ends between the protruded strips 26 provides an additional force to fix the nasal reinforcer 20 on the nasal portion 13. In this fourth exemplary embodiment, four pairs of protruded strips 26 are included in the nasal portion 13. However, in other embodiments, there may be only two pairs of protruded strips 26, which are located either on exterior or interior surface of the face piece's nasal portion 13.

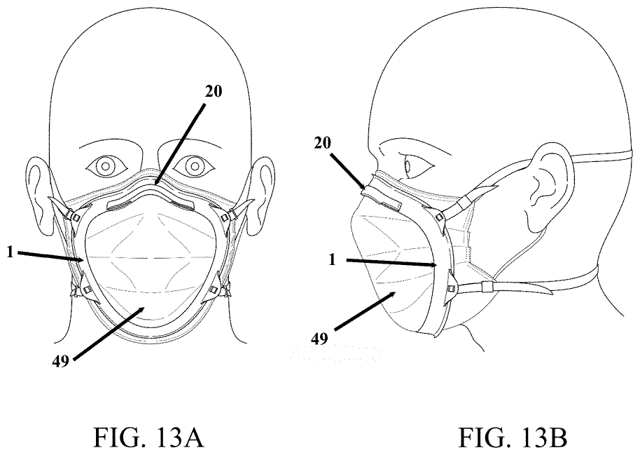

FIGS. 13A-13B illustrate a user wearing the fourth exemplary embodiment of the mask fixer 1, which includes the nasal reinforcer 20, on a surgical mask 49, to prevent air leak at the edges of the surgical mask 49.

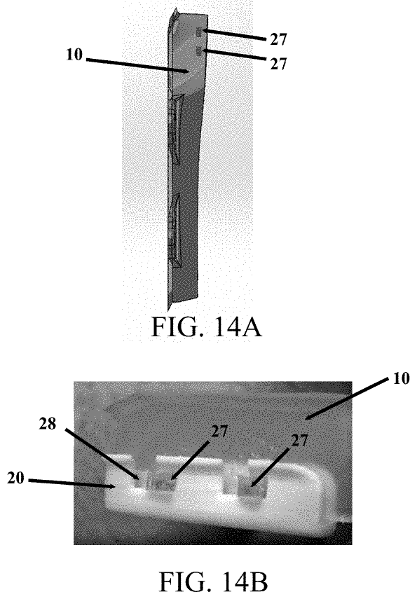

As illustrated in FIGS. 14A-14B, in a fifth exemplary embodiment of the mask fixer 1, which includes the nasal reinforcer 20, the nasal reinforcer 20 is also made from a rigid polymer and is formed separately from the face piece 10. As illustrated in FIG. 14A, there are two protruded blocks 27 on one side of the face piece's nasal portion 13. There are also another two protruded blocks 27 on the opposite side of the nasal portion 13. As illustrated in FIG. 14B, the nasal reinforcer 20 has a channel 23, as the nasal reinforcer 20 in the third exemplary embodiment of the mask fixer 1. The nasal reinforcer 20 also has four L-shaped slots 28. The four L-shaped slots 28 are located on the exterior surface of the nasal reinforcer 20, and two L-shaped slots 18 are located on either side of the nasal reinforcer 20, as illustrated in FIG. 14B.

In the fifth exemplary embodiment of the mask fixer 1, which includes the nasal reinforcer 20, the assembly of the reinforcer 20 into the face piece 10 is as follows: (i) the face piece's nasal portion 13 is squeezed towards the center of the nasal portion 13 using fingers, (ii) the nasal reinforcer 20 is inserted into the nasal portion 13, and (iii) the nasal portion 13 is stretched to have its four protruded blocks 27 move to the ends of the four L-shaped slots 28, respectively. The protruded blocks 27 inside the L-shaped slots 28 help to fix the reinforcer 20 on the face piece's nasal portion 13. Although this fifth exemplary embodiment includes four protruded blocks 27 in the nasal portions 13 and four L-shaped slots 28 in the nasal reinforcer 20, in other embodiments, there can be different numbers of protruded blocks 27 and L-shapes slots 28, such as two, six or more.

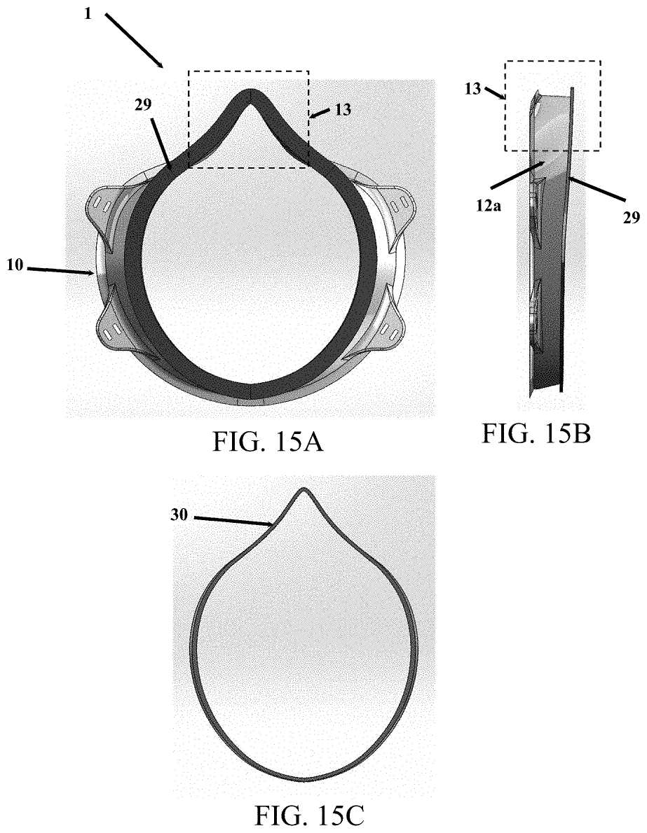

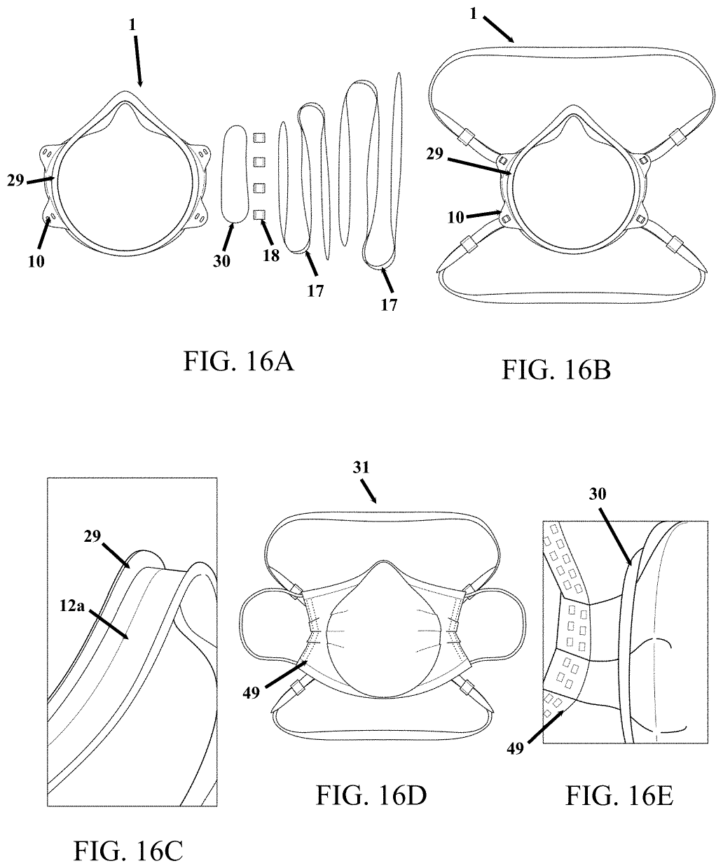

As shown in FIGS. 15A-15B and 16A-16C, in some embodiments of the mask fixer 1, a circumferentially extending flange 29, instead of the nasal reinforcer 20, is added to the face piece 10. The flange 29 is added around the central aperture 11 of the face piece 10. Also, a band 30 is included in these embodiments of the mask fixer 1, as illustrated in FIGS. 15C, 16A and 16E.

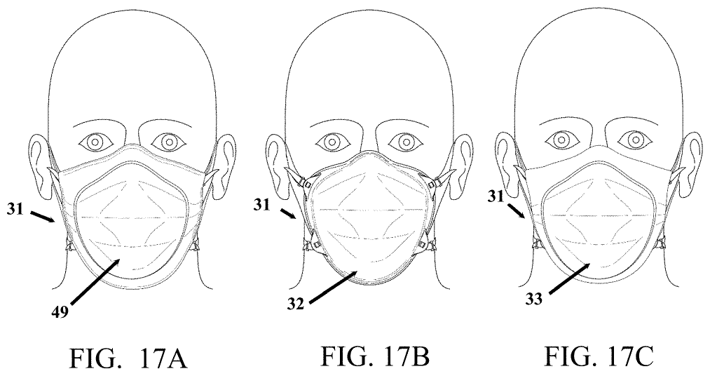

The flange 29 has a protruded portion, which is above the face piece's exterior surface 12a, as illustrated in FIGS. 15B and 16C. A surgical mask 49, for instance, is fixed on the face piece 10, by using the band 30 to wrap the surgical mask 49 around the flange's protruded portion, as illustrated in FIGS. 16D-16E. The direct integration of the mask fixer 1 with the surgical mask 49 results in a first new face mask 31. As illustrated in FIG. 17A, this new face mask 31 can be directly worn on a user's face 48. Compared with the case that a user has to wear two separate apparatus on the face: a surgical mask 49 and a mask fixer 1, in this embodiment the integration of the surgical mask 49 to the mask fixer 1 creates a one unit face mask 31. In addition, the flange 29 also increases the bending stiffness of the face piece 10. Due to this reinforcement, the face piece's nasal portion 13 is not distorted by the pulling force applied by a user to wear the face mask 31, and the nasal portion 13 still remains its pre-curved profile. The back part of the nasal portion 10, which does not have direct contact with the flange 29 along the direction normal to a user's nasal bridge while has direct contact with the user's nasal bridge, is locally pushed outwards by the nasal bridge, until it conforms to the contour of the user's nasal bridge, making the face piece have a good fit around the nose.

Another two exemplary embodiments of the face mask 31 are illustrated in FIGS. 17B-17C. In the exemplary embodiment of the face mask 31 as shown in FIG. 17B, a surgical mask 49 is replaced with a filter with a teardrop profile 32. In the exemplary embodiment of the face mask 31 show in FIG. 17C, a surgical mask 49 is replaced with a commonly used cloth mask 33.

In some embodiments, the flange 29 is made from a flexible polymer. In some cases, the flexible polymer can be any flexible polymer not inconsistent with the objectives of this disclosure, such as a flexible polymer suitable for compression or injection molding. In some instances, the flexible polymer is thermoplastic polyurethane (TPU), thermoplastic elastomer (TPE), thermoplastic polyurethane (TPU) or thermoplastic elastomer (TPE), soft-flexible polylactic acid (PLA), soft-flexible Polydimethylsiloxane (PDMS), elastomeric polyurethane (EPU), flexible polyurethane (FPU) or silicone.

In other embodiments, the flange 29 can be made from any rigid polymer not inconsistent with the objectives of this disclosure, such as 3D printable, compression or injection moldable, or castable rigid polymers. Exemplary rigid polymers include polyphenylsulfone (PPSU), polyvinyl chloride (PVC), polypropylene (PP), polyethylene (PE), polystyrene (PS), nylon, polyethylene terephthalate (PET), polyimide (PA), polycarbonate (PC), acrylonitrile butadiene (ABS), polyetheretherketone (PEEK), polyurethane (PU), polylactic acid (PLA), Polycaprolactone (PCL), high-density polyethylene (HDPE), polyethylene high-density (PEHD) or any combination thereof.

In some cases, the flange 29 can be made from a combination of rigid and/or flexible polymers. For instance, the core of the flange 29 is made of PC, and the remaining portions of the flange 29 can be made with silicone, with the face piece 10 also made of silicone. In this example, silicone in the flange 29 helps to bond the flange 29 to the face piece 10. Also, silicone is generally softer than PC, so the mask fixer 1, which includes the flange 29, can still be comfortable to wear.

In other cases, the flange 29 can be made from a metal. Exemplary metals include aluminum, copper, or steel.

In preferred embodiments, the flange 29 is part of the face piece 10, and it is manufactured with the face piece 10 at the same time using the same process (e.g. compression or injection molding) and the same material (e.g., silicone).

In other embodiments, the flange 10 is formed separately from the face piece, and it is assembled to the face piece via over-molding, insertion or bonding.

The band 30 is made from a flexible polymer. In some cases, the flexible polymer can be any flexible polymer not inconsistent with the objectives of this disclosure, such as a flexible polymer suitable for compression or injection molding. In some instances, the flexible polymer is thermoplastic polyurethane (TPU), thermoplastic elastomer (TPE), thermoplastic polyurethane (TPU) or thermoplastic elastomer (TPE), soft-flexible polylactic acid (PLA), soft-flexible Polydimethylsiloxane (PDMS), elastomeric polyurethane (EPU), flexible polyurethane (FPU) or silicone. In preferred embodiments, the band 30 is made from silicone using compression or injection molding.

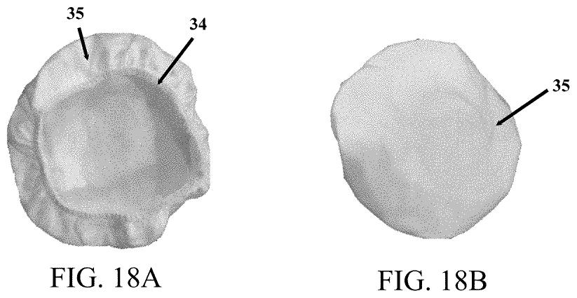

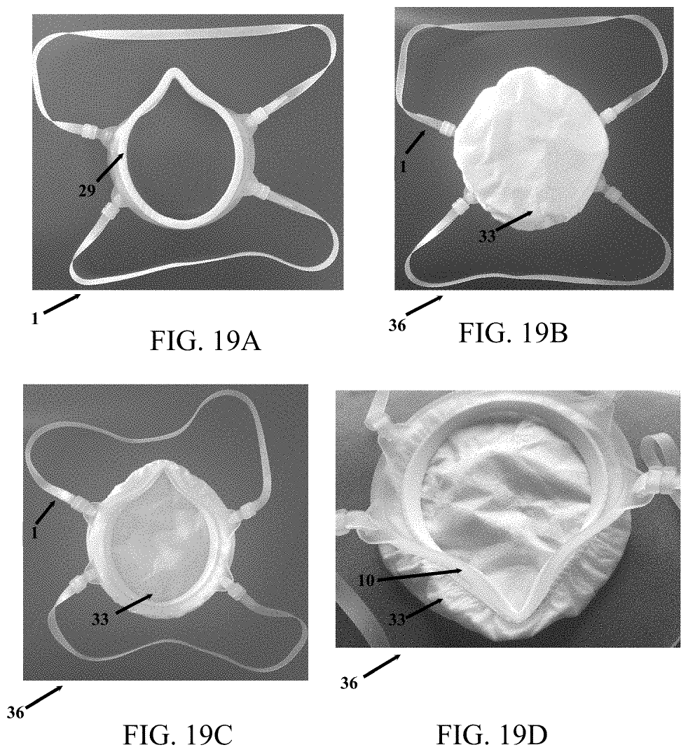

A flexible filter sheet 33 is shown in FIGS. 18A-18B. It is formed by gluing, sealing, bonding or sewing a flexible filter band 34 around the edge of a flexible mask filter 35. FIG. 19A shows an embodiment of the mask fixer 1. A similar embodiment has been previously presented in FIG. 16B. The flexible filter band 34 has a smaller diameter than the flange 29 of the embodiment of the mask fixer 1. The flexible filter sheet 33 is attached to the face piece 10, by stretching and then wrapping the flexible filter band 34 around the flange 29 of the face piece 10, providing a second new face mask 36. FIGS. 19B-19D give the top, bottom, and close-up bottom views of the second new filtered mask fixer face mask 36. The flexible filter sheet 33 appears flat in this exemplary embodiment (FIG. 18B). In other cases, this flexible filter sheet 33 can have a cup, butterfly, triangular, oval, or rectangular shape.

The flexible filter band 34 is made from a flexible polymer. In some cases, the flexible polymer can be any flexible polymer not inconsistent with the objectives of this disclosure, such as a flexible polymer suitable for compression or injection molding. In some instances, the flexible polymer is thermoplastic polyurethane (TPU), thermoplastic elastomer (TPE), thermoplastic polyurethane (TPU) or thermoplastic elastomer (TPE), soft-flexible polylactic acid (PLA), soft-flexible Polydimethylsiloxane (PDMS), elastomeric polyurethane (EPU), flexible polyurethane (FPU) or silicone. In preferred embodiments, the band 30 is made from silicone using compression or injection molding.

The mask filter 35 is made of a fibrous material and is preferably permeable to air so that the wearer can breathe easily. Non-limiting examples of fibrous materials which can be used for the mask filter 35 are cellulosic fiber, glass fiber, mineral fibers, nylon fiber, acrylonitrile fiber, wool or other natural organic fibers, polyester fiber, and the like. Preferably the fibers are formed into a sheet by a random felting procedure rather than being woven although both types are operable in this invention. The mask filter 35 may also be formed from a flexible fabric laminate of layers of a nonwoven material including, but not limited to, polypropylene nonwovens such as spunbond, meltblown, spunbond (SMS) commercially available from Kimberly-Clark Corporation. See, also, U.S. Pat. No. 5,561,863.

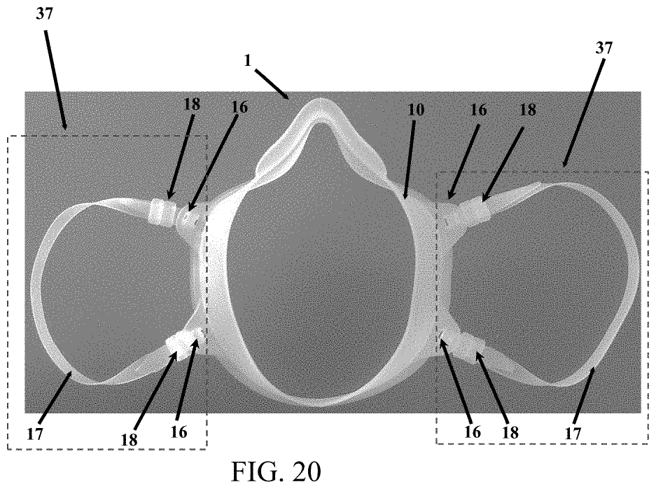

FIG. 20 shows an embodiment of the mask fixer 1 that provides adjustable ear loops 37. The ear loops 37 can be worn around the user's ears, instead of around the head. The ear loops 37 are formed by piercing the user straps 17 through the strap receiving apertures 16 of the face piece 10. The user straps 17 are self-locked in a set of strap receiving apertures 16. A user can tighten or loosen the ear loops 37 by pulling the user straps 17 forward or backward, to create a seal of the face piece 10 around the user's face 48.

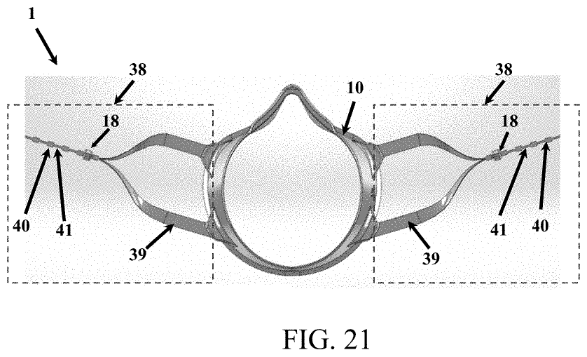

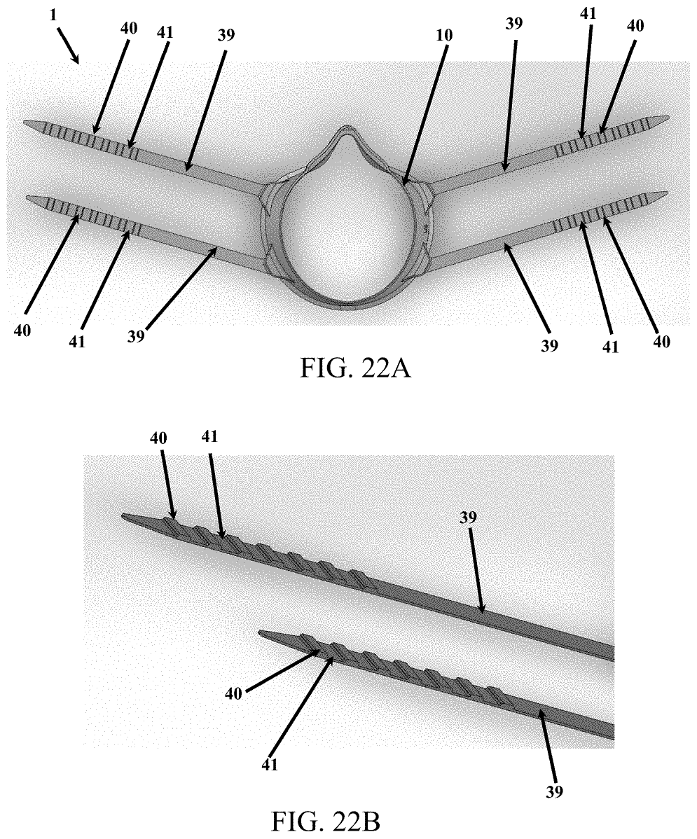

FIG. 21 shows another embodiment of the mask fixer 1 that provides adjustable ear loops 38. In this embodiment, four ear straps 39 are part of the face piece 10 (FIGS. 22A-22B) and will be formed with the face piece 10 at the same time using the same process (e.g., compression or injection molding). There are steps 40 on each ear strap 39 (FIGS. 22A-22B). There is a groove 41 between two neighboring steps 40. Loops 18 will be formed separately but using the same process (e.g., compression or injection molding) and the same material (i.e., silicone) as the face piece 10. A loop 18 is used to clamp a pair of ear straps 39, to form an ear loop 38 (FIG. 21). The height of the hole 19 of the loop 18 approximately equals the total thickness of a step 40 and an ear strap 39, and it is about half of the total thickness of two steps 40 and two ear straps 39. Therefore, the loop 18 is locked on the grooves 41 of ear straps 39, while the loop 18 can still be moved over steps 40 of an ear strap 39 to adjust the length of the ear loop 38. The silicone materials used for different parts of the mask fixer in this embodiment may have different harnesses. For instance, the silicone material used for the face piece 10 may have a shore hardness of 60 A or 70 A, while the silicone material for the ear straps 39 may have a shore hardness of 30 A. The loop 18 has a shore hardness of 70 A or 80 A.

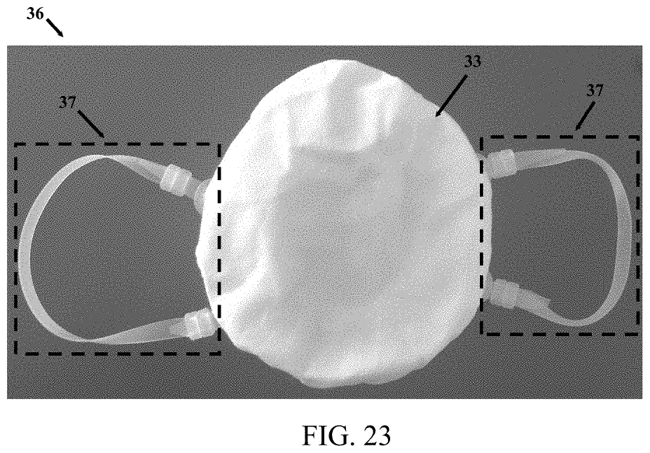

The head straps 17 in the first new face mask 31 and the second new face mask 36 can also be replaced with the adjustable ear loops 37 or 38. An embodiment of the second new face mask 36 is shown in FIG. 23 that has adjustable ear loops 37.

The performance of an embodiment of the mask fixer 1 was examined. This embodiment was similar to the first embodiment of the mask fixer 1 (FIGS. 8A-8C). The only difference is that in the tested embodiment, to clamp strap heads 45 to the head straps 17 for a better appearance, the number of the strap loops 8 used for the mask fixer 1 was eight, instead of four. In the tested embodiment of the mask fixer 1, the silicone material used for the face piece 10 had a shore hardness of 70 A, the silicone material for the two user straps 17 had a shore hardness of 30 A, and the silicon material for the eight strap loops 18 had a shore hardness of 80 A. With and without the mask fixer 1, Defender Safety face masks were tested by ICS Laboratories in Ohio, USA for quantitative leakage assessment, in general accordance with an abbreviated form of ASTM F3407-20, the Standard Test Method for Respirator Fit Capability for Negative-Pressure Half-Facepiece Particulate Respirators (Table 1). This testing utilized 10 total human subjects. Each subject donned a mask without modification, assessing the fit with the mask's own ear loops, as well as using a mask fixer 1.

TABLE 1
Materials for quantitative leakage assessment

| Model Number | Description | Qty |
|---|---|---|
| Defender Safety | Medical grade ASTM level 3 | 20 |
| | procedure face mask | |
| LM Mask fixer | Silicone mask fixer | 10 |

All tests were conducted in a standard laboratory atmosphere unless otherwise specified. The equipment and instrument calibrations were verified current and within specification prior to use. The materials for assessment were inventoried, numbered, and logged upon receipt.

A TSI PortaCount Model 8048 was used to perform the quantitative leakage evaluation in accordance with OSHA 29 CFR 1910.134 PROTOCOL. The system was validated and underwent daily checks per the manufacturer's recommended procedure. The system was operated in N95 companion mode, an operational mode intended to be used with devices which provide submicron filtration at <99% efficiency.

Ten subjects were selected to perform the abbreviated fit capability testing. The testing environment's relative humidity was maintained below 40%. All subjects selected underwent facial width and length measurements to classify them within the NIOSH bivariate panel, available in the standard. Each subject donned a ported face mask, once without modification and once with the provided mask fixer 1. The system monitored ambient particulates both inside and outside of the mask, calculating a respirator face capability (RFC) factor for each exercise as well as an overall RFC factor for each subject. The RFC refers to the ratio between the particulates outside and inside the mask. A passing score is 100, which indicates that only 1 out of 100 outside particulates gets inside the mask. When abnormally low RFCs were observed, testing was stopped, the mask was redonned and the TSI ProtaCount's live fit factor mode was used to troubleshoot potential leak points. Each subject performed the following exercises, each for one minute: normal breathing, deep breathing, turning head side-to-side, moving head up-and-down, speaking aloud, bending forward at the waist and normal breathing.

The results of the quantitative leakage of the Defender Safety medical face mask are provided in Table 2.

TABLE 2
Quantitative Leakage Test Results - Defender Safety Medical Grade Face Mask without the mask fixer 1.

| | Bivariate | Individual Exercise RFC | | | | | | | |
|---|---|---|---|---|---|---|---|---|---|
| Subject | Panel | Normal | Deep | Head | Head | Speaking | Bending | Normal | Overall |
| ID | Cell | Breathing | Breathing | Side-to-side | Up-and-Down | Aloud | at Waist | Breathing | RFC |
| SDT | 1 | 1 | 1 | 1 | 1 | 1 | 1 | 1 | 1 |
| ALT | 2 | 2 | 1 | 2 | 1 | 1 | 1 | 1 | 1 |
| PJS | 3 | 7 | 7 | 6 | 6 | 10 | 8 | 12 | 7 |
| KAA | 4 | 6 | 6 | 7 | 6 | 8 | 7 | 8 | 7 |
| AG | 4 | 2 | 2 | 2 | 2 | 2 | 2 | 3 | 2 |
| JPM | 5 | 1 | 2 | 1 | 1 | 1 | 2 | 2 | 1 |
| DJM | 6 | 1 | 2 | 2 | 2 | 6 | 2 | 2 | 2 |
| JAL | 7 | 7 | 11 | 6 | 11 | 11 | 9 | 7 | 8 |
| DM | 8 | 4 | 3 | 2 | 2 | 3 | 3 | 3 | 3 |
| JLM | 9 | 1 | 2 | 2 | 2 | 3 | 2 | 1 | 2 |

The results of the quantitative leakage of the Defender Safety medical face mask with the mask fixer 1 are provided in Table 3.

TABLE 3
Quantitative Leakage Test Results - Defender Safety Medical Grade Face Mask with the mask fixer 1.

| | Bivariate | Individual Exercise RFC | | | | | | | |
|---|---|---|---|---|---|---|---|---|---|
| Subject | Panel | Normal | Deep | Head | Head | Speaking | Bending | Normal | Overall |
| ID | Cell | Breathing | Breathing | Side-to-side | Up-and-Down | Aloud | at Waist | Breathing | RFC |
| SDT | 1 | 111 | 102 | 100 | 66 | 96 | 27 | 41 | 61 |
| ALT | 2 | 200+ | 200+ | 130 | 200+ | 200+ | 200+ | 57 | 140 |
| PJS | 3 | 122 | 135 | 192 | 200+ | 57 | 93 | 115 | 112 |
| KAA | 4 | 200+ | 131 | 104 | 155 | 200+ | 97 | 94 | 128 |
| AG | 4 | 200+ | 200+ | 200+ | 200+ | 200+ | 200+ | 200+ | 200+ |
| JPM | 5 | 150 | 200+ | 138 | 126 | 147 | 58 | 64 | 105 |
| DJM | 6 | 200+ | 71 | 32 | 52 | 34 | 10 | 32 | 81 |
| JAL | 7 | 200+ | 200+ | 200+ | 200+ | 200+ | 200+ | 200+ | 200+ |
| DM | 8 | 3 | 4 | 4 | 4 | 2 | 2 | 3 | 3 |
| JLM | 9 | 15 | 24 | 19 | 18 | 59 | 11 | 12 | 17 |

Note:
A fit factor of 200 is the maximum attainable value while operating the TSI PortaCount Model 8048 in N95 companion mode.

With the mask fixer 1, 6 out of 10 test subjects have obtained an overall RFC result≥105, over the passing score of 100 (see last column of Table 3). The mask fixer 1 was effective on 9 out of the 10 test subjects. On average, the mask fixer 1 has increased the RFC factors of all subjects by about 30 times, from 3.4 to 105. It was calculated according to the last column of Tables 2 and 3, with 200+ counted as 200. In other words, with the mask fixer 1, the air inside a Defender Safety medical face mask was about 30 times cleaner on average.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

We claim:

1. An apparatus, the apparatus comprising:
a. a main body, wherein the main body comprises a first surface and a second surface;
b. a central aperture;
c. a plurality of projections, wherein the projections are configured to secure the apparatus to a surface; and,
d. one or more securing devices configured to be received by one or more projections of the plurality of projections.

2. The apparatus of claim 1, wherein the apparatus is formed by compression or injection molding.

3. The apparatus of claim 1, wherein the apparatus further comprises a first edge abutting at least a portion of the face of a user and a second edge abutting a central aperture, wherein the second edge opposes the first edge.

4. The apparatus of claim 1, wherein at least a portion of the first surface or the second surface abuts at least a portion of the face of a user, and wherein the opposing portion does not.

5. The apparatus of claim 1, wherein the plurality of projections is attached to the surface that does not abut the face of a user of the main body, and wherein the plurality of the projections extend outwardly from said surface.

6. The apparatus of claim 1, wherein each of the plurality of projections comprises one or more apertures configured to receive one or more securing devices.

7. The apparatus of claim 1, wherein the main body comprises a nasal portion that is pre-curved has a smaller profile than a generic nasal bridge and is configured to expand outwards to conform to the nasal bridge of a user and, wherein conforming to the nasal bridge forms a seal.

8. The apparatus of claim 7, further comprising a nasal reinforcer simultaneously abutting the second edge and the surface of the main body not abutting the face of a user, wherein the nasal reinforce is located on a portion of the nasal portion of the main body.

9. The apparatus of claim 8, wherein the nasal reinforcer provides additional local thickness and rigidity maintaining the pre-curved profile of a user's nasal bridge.

10. The apparatus of claim 8, wherein a portion of the nasal portion not abutting the nasal reinforce expands outward and conforms to the contour of the user's nasal bridge to make a seal.

11. The apparatus of claim 8, wherein the nasal reinforcer is pre-formed into the main body and is made from the same material as the main body.

12. The apparatus of claim 8, wherein the nasal reinforcer is formed separately from the main body, and is subsequently joined to the face piece via casting, over-molding, insertion, screwing fit, or snapping fit.

13. The apparatus of claim 1, wherein the one or more securing devices secure the apparatus to the face of a user by forming one or more loops around a user's head or ears.

14. The apparatus of claim 8, wherein the securing devices are pre-formed into the apertures of the plurality of projections of the main body.

15. The apparatus of claim 1, wherein the securing devices comprise an adjustable length.

16. The apparatus of claim 1, wherein the one or more securing devices are formed separately from the main body and subsequently inserted into the apertures of the plurality of projections.

17. The apparatus of claim 1, wherein the securing devices are wider than the apertures of the plurality of projections.

18. The apparatus of claim 1, further comprising a flange extending outwards from the second edge.

19. The apparatus of claim 18, wherein the flange and main body form a notch capable of receiving a flexible band.

20. The apparatus of claim 19, further comprising:
a. a filter sheet; and
b. a flexible filter band having a smaller diameter than the main body of the apparatus, wherein the flexible filter band is glued, bonded or sewn to the filter sheet, wherein the filter sheet is attached to the face piece by stretching the flexible filter band around the apparatus and securing the flexible filter band within the notch to form a sealed mask.
